(19) United States
(12) Patent Application Publication
(10) Pub. No.: US 2003/0150915 A1
(43) Pub. Date: Aug. 14, 2003

(54) IC card authorization system, method and device

(76) Inventor: Kenneth Reece, Arroyo Grande, CA (US)

Correspondence Address: Mr. Kenneth Reece, 3689 Alisos Road, Arroyo Grande, CA, 93420, US

(21) Appl. No.: 10/314,046

(22) Filed: Dec. 6, 2002

Related U.S. Application Data
(60) Provisional application No. 60/340,349, filed on Dec. 6, 2001.

(51) Int. Cl. G06K 7/08

(52) U.S. Cl. 235/449

(57) ABSTRACT

A card read/write device comprises means for storing and updating authorization information regarding specific cards and/or card types which are authorized for use with said card read/write device. Even if a certain card is complying with the standards under which the card read/write device operates, and therefore in theory should be allowed to be used with said device, the card read/write device comprises means for denying or accepting the use of the card, each time the card is presented to the device.

The functionality to accept or deny a specific card and/or card type can be altered repeatedly in the lifespan of the card reader by storing—and providing means for updating authorization data in the card read/write device. The process to update the authorization data of the card read/write device, could be any hardware or software based method, such as a button on the smart card reader, an application stored in a smart card, an application stored on a computing device which is coupled to the card reader or by downloading updated information via a network such as the Internet.

The advantage of the present invention, is that it provides card reader providers and/or card issuers a means to control and prevent unauthorized use of the card read/write device, which said card reader provider have provided. The reader provider retains control over which cards can be used with the card read/write device, and thus the card reader provider has the freedom to enter into agreements with other card issuers, to authorize the use of card issuer's cards, with the provided card readers.

In alternate embodiments, the authorization data is not stored in the card reader, but in other locations, and looked up by the card reader when authorization of a card is required.

### CROSS-REFERENCE TO RELATED APPLICATION

This application is entitled to the benefit of Provisional Patent Application Serial No. 60/340349 filed Dec. 6, 2001.

### FEDERALLY SPONSORED RESEARCH

Not applicable

### SEQUENCE LISTING OR PROGRAM

Not applicable

### BACKGROUND—FIELD OF INVENTION

The present invention relates generally to card read/write devices and specifically authorization of the use of different card types with said card read/write device.

### BACKGROUND—USED TERMINOLOGY

Network

In the context of the invention the term “network” is used to describe any network where a plurality of computers, computing devices or game devices, are linked together, either through at least one server or through a peer-to-peer connection. A few examples of such networks are:

A public network like the Internet

Proprietary networks like AOL and Compuserve

Corporate Intranets

Hotels' internal network

Automated Teller Machine (ATM) networks

The term “network” is used to describe both wired and wireless networks.

Connection

In the context of the invention the term “connection” is used to describe any means for coupling two devices, either through a wired connection or through a wireless connection, or a wireless link.

Smart Card

In the context of the invention the term “smart card” is used to describe all types of cards of the kind incorporating a hybrid or monolithic integrated circuit or “microchip”. In the context of the invention, the term “smart card” is used to refer to both contact smart cards and contact-less smart cards.

The term “smart card” is also used to describe a microchip by it self, or integrated with other objects or devices, in particular portable objects and devices. Examples of such objects and devices are credit cards, memory cards, SIM cards (such as those used in cellular phones), keys or key rings. The term “card” is further used to describe the microchip integrated with any other object than those mentioned in the example.

In this disclosure, the terms “smart card”, “IC card” and “chip card” will be used interchangeably to denote integrated circuit cards of this type.

In the appended claims the term “portable electronic storage device” is used to refer to both smart cards as well as any other portable device that fit the description.

Card

In the context of the invention, the term “card” is used to describe both smart cards and non-smart cards such as magnetic stripe cards, bar code cards etc.

The term card is also used to describe any generic functionality card such as payment cards, ID cards, Loyalty cards, Drivers license cards etc., regardless of what card technology is used with those functionality cards.

Card Read/Write Device

In the context of the invention the term “card read/write device” is used to describe any device having means for reading information from—and/or writing information to a card as defined above. Examples of such card read/write devices is a smart card POS (Point Of Sale) terminal, other POS terminals, a PC smart card read/write device, a cellular telephone, a satellite receiver, a magnetic stripe reader, a vending machine, a photo copier, an Automated Teller Machine (ATM) etc.

In the appended claims the term “electronic storage and transaction apparatus” is used to refer to both a card read/write device, as well as any other device that fit the description.

PCB

The term “printed circuit board” or “PCB” is used to describe any type of circuit board with interconnecting conductors, regardless of the method used to manufacture said circuit board.

Casino Game

In the context of the present invention the term “casino game” is used to describe any game that can be played for money. These games include every game played in any traditional casino or Internet casino, but also video games and sports bets and other bookmaker bets are referred to in the following as a “casino game”.

Remote Player

In the context of the invention, the term “remote player” is used to describe any player that is playing a game over a network.

Remote Game

In the context of the invention, the term “remote game” is used to describe any game that is played over a network.

Computer Peripheral Device

In the context of the invention the term “computer peripheral device” is used to describe any electrical device that can be used with a computer, even if such devices in the context of the invention is described as a stand-alone unit or used with another device than a computer.

“Display of the device”

In the context of the invention the term “display of the device” is used to describe any means for displaying information such as game results, a card balance or instructions to a user. The display can either be comprised directly in the device of the present invention or it can be attached to the device as a separate device. A monitor attached to a computer, or a display of another device, that is used to display information such as gaming results and other information related to activities carried out using the device of the present invention is also referred to as the “display of device” in the following.

License Grant Process

In the context of the present invention, the term “License Grant Process” is used to describe the process a user have to go through in order to have an un-authorized card authorized for use with a card reader. Although a preferred embodiment is described in the following, it is noted that any License Grant Process falls within the scope of the present invention.

License Grant Action

In the context of the present invention, the term “License Grant Action” is used to describe an action a user can perform as an alternative—or a supplement to regular payment, in order for the user to have an un-authorized card authorized for use with a card reader. A few examples are described in the following, but it is noted that any kind of action a user can take to satisfy the requirements to have a card authorized for use with a card reader, falls within the scope of the present invention.

License Options

In the context of the present invention, the term “License Option” is used to describe the different options a user is presented with, when a request has been made to have a card authorized for use with a card reader. One example of a License Option could be the payment of a yearly fee to authorize an unlimited number of different cards for use with a card reader. Another option could be payment of a small fee, each time an unauthorized card is to be used with the card reader. The number and content of different License Options, will be determined by the card reader providers and/or card issuers, but it is noted that any License Option or any combination of a plurality of license options falls within the scope of the present invention.

Interval Fee

in the context of the present invention, the term “Interval fee” is used to describe a fee, such as a monthly, a quarterly or a yearly fee, that falls due within regular intervals.

Payment Options

In the context of the present invention, the term “Payment Option” is used to describe the options a user is given, when payment is required to authorize a card for use in a card reader. A number of different payment options are mentioned as examples in the following, but it should be noted that any means of gratification to a card reader provider, that leads to an authorization of a card for use with a card reader, is considered a payment option, regardless of the payment option involves payment with money or other means (for example a License Grant Action).

Electronic portable storage device

In the context of the present invention, the term “Electronic portable storage device” is used to refer to any portable electronic device that comprises means for storing data. A few examples are: a smart card, a cell phone, a PDA, a portable computer, an electronic book reader, a watch with a memory etc.

Electronic Storage and Transaction Apparatus

In the context of the present invention, the term “Electronic storage and transaction apparatus” is used to refer to any apparatus, which comprises means for storing data and performing transactions. A few examples are: Smart card read/write devices, POS terminals, Vending machines, ATMs, cell phones etc.

### BACKGROUND—INTRODUCTION TO THE SMART CARD INDUSTRY

Description of Smart Cards

The microcircuit of a smart card is usually based on a microprocessor or a micro-controller including memory circuits, for example of the “PROM” or “EPROM” type. Data can be stored in the aforementioned memory circuits, usually in encrypted form. Some common uses of smart cards include storing value, storing information for use for identification purposes, or for access control. The data is read from memory locations and/or written to memory locations.

Other logical architectures are used in particular for “electronic purse” or similar type applications.

To read information from a card or write information to a card, a device must be provided wherein a card can be inserted for reading and/or writing data to and from the card. For the sake of simplicity, such a device will be referred to as a “reader” or a smart card reader, it being understood that it can equally write data and perform other ancillary functions (such as electrical power supply, presence tests etc.) referred to hereinafter and in the prior art.

In all cases a smart card incorporates at least one electronic component, which comprises input/output members to which a link must be established, either through an electrical connection (in the case of a contact smart cards) or through a wireless connection (in the case of a contact-less smart cards). Said input-output members are often provided in the form of contact areas, also known as “pads”, flush with the surface of one of the principal faces of the card. Various standards (ISO, AFNOR, etc.) define the position and lay out of these contact areas. They are used not only for the aforementioned data inputs-outputs but also to supply electrical power to the microcircuit and to enable various checks to be carried out, according to the applications concerned (presence test, etc.).

Contact smart cards traditionally are formed of a plastic plate having about the same thickness as a credit card, with an integrated circuit imbedded in the plastic and with contact pads on a surface of the card. Such cards come in different sizes, with the large size commonly being about the size of a credit card and with a popular small size being referred to as a MICROSIM or simply SIM card. The prior art has provided a plurality of other forms of smart cards, for example where a microchip is embedded in a key or a device to place on a wrist for access control. Often these devices are referred to as tokens. For the sake of simplicity these tokens are also referred to as cards in the context of the present invention. The form or shape of the smart card is not important to this invention as it can be adapted to be used with any type of Integrated Circuit card, no matter what form or shape.

Description of Link Between Card and a Computing Device

The contact smart cards are inserted into connectors that make contact between the contact pads of the card and a plurality of contacts comprised in the connector to establish an electrical connection to the electronic components of a circuit board (such as a PCB).

The contact-less smart cards uses wireless means of communication, such as Radio Frequencies, to couple the smart card and the electronic components of a PCB. A conductive path is provided on a PCB to form an integral antenna, which is used to communicate with the smart card.

Smart Cards in Use

Smart cards are particularly adapted for use in industries requiring strict access or billing control and convenient as well as secure access to sources of payments and information. Such applications include public phones, vending machines, copy machines, laundry machines, public transportation ticketing and portable devices such as cellular phones, pagers, PDA's, laptop computers and other similar electronic devices and also stationary devices such as a PC, a satellite receiver or a telephone. Such cards can also be used in applications relating to payments, identification, loyalty programs, citizen cards, electronic elections, health services, ticketing, security access, software copy-protection, building access and machine controls etc.

The cards are commonly used to authorize transactions such as purchases of goods, for access control, for identification purposes, and to allow operation of an automobile radio or a lock. Use of smart cards for secure identity authentication purposes and for online payment transactions over the Internet are expected to increase in the next few years.

Today there are many hundred million smart cards in use around the world. Although many uses have been proposed and developed, today smart cards are mainly used as prepaid phone cards, as Satellite TV cards or as SIM cards in cellular phones.

In recent years banks and financial institutions have begun to issue smart card credit cards, in order to prepare for the future, merchants have begun to issue smart cards as loyalty cards, government agencies are using smart cards to control access to buildings, transit authorities are using smart cards to store tickets and cities are using them for parking purposes.

Introduction of the Object of a Smart Card Reader

In order to effect electrical connection between a contact smart card and the electronic components of a PCB, an electrical connector or smart card reader is employed such that the connector securely accommodates the smart card therein. The connector serves as an interface between a smart card and a reading system that interprets the information contained in the card. A few examples of such a reading system are a computer, a satellite receiver, a cell phone, a pay phone, an electronic lock etc.

In order for a user to take full advantage of the possibilities that smart cards offer, in particular to use a smart card over a network connection (such as the Internet), a card reader must be attached to the user's computer. The card reader establishes a link between the information comprised in a microchip on the smart card and a computer.

As smart cards are becoming more commonplace, the participants in the smart card industry such as smart card manufacturers, system providers and card issuers such as banks or credit card companies and different card based loyalty programs, are all facing the same common problem that there is no infrastructure in place, to facilitate the widespread use of smart cards.

As more and more consumers, businesses and public organizations are provided with smart cards, there arises a need to supply those cardholders with a smart card reader, in order to take advantage of the full functionality of smart cards. Most smart cards are equipped with an integrated chip, a memory and a microprocessor, and in order to access the information or applications that is stored on the chip, a smart card reader is required as discussed above.

The Smart Card Industry's Problem

The chip on today's smart cards are almost never used from the cardholder's PC, simply because almost no card readers have been distributed and installed on consumer's (or even businesses) PCs.

Because only a very limited number of cardholder's have the capability to use their smart card over the Internet, there are almost no possibilities being provided of using a smart card over the Internet. When there is nothing—or very little a card holder can use her smart card for over the Internet, it is not likely that she will invest the time and money to acquire a smart card reader and connect it to her PC. This paradox is the main problem that is facing the smart card industry and the card issuers.

There are a few conceivable solutions to this problem. One solution is if the PC manufacturers bundle a smart card reader with new PC systems. This involves an extra cost to the PC manufacturers, and therefore it is not likely to happen on a big scale before the consumers demand—and expect it.

Another more conceivable solution is, that the card issuers provide a free (or subsidized and thus very cheap) smart card reader when they issue a smart card. There is a common consensus in the smart card industry, that it is likely that card readers will be provided—and possibly subsidized by the card-issuers, such as financial institutions.

With the solutions that the present invention provide, it is now also very conceivable that a company invest in building the smart card reader infrastructure, by giving out millions of free card readers, and subsequently charge a fee from the card issuers, and/or card holders who wishes to make use of the infrastructure that has been built.

Many industry sources predict that smart card readers will become as commonplace as computer mice is today, and once this happens, the infrastructure will be in place to start using smart cards to their full potential. The prediction is that a cardholder will have a smart card reader connected to a computer, and when the card is inserted into said card reader, the information and applications on the smart card can be accessed. This will allow the use of smart cards over the Internet, for example to make secure payment transactions or to verify the card holders identity by inserting the card into the reader and entering a corresponding PIN code.

All the major credit card associations and companies (VISA, MasterCard, American Express) have announced global strategies, to shift from the use of magnetic stripe cards to smart cards, because smart cards provide added security and added functionality compared to today's credit cards. The shift is expected to take place over the next 4-5 years.

It is therefore very likely that a few years from now, most consumers will carry a smart card, many will carry more than one smart card and often from different card issuers with each card having different functions (National ID, credit card, cash card, health care etc.).

If a card issuer (for example a bank) tries to establish a proprietary smart card system, where the card can not be used outside that particular bank's network, or a if a card reader provided by the bank could not be used to read cards from other card issuers, it would eventually force the consumers to connect several different card readers to a computer, to be able to read different cards. No one would benefit from this scenario, because most likely the consumer's would simply avoid smart cards. The banking—and smart card industry realizes this, and common standards for smart cards, and card readers have therefore been developed. One such standard for card readers is the FINREAD standard, which was developed by a number of leading European financial institutions. The documentation on the specifications of a FINREAD smart card reader, as found on www.finread.com is included herein in its entirety by reference. Other smart card standards and platforms include Java Card (www.java.sun.com), Global Platform (formerly Visa Open Platform) (www.globalplatform.org), Multos (www.multos.com), Open Card (www.opencard.org), PC/SC (www.pcscworkgroup.com). The publicly available specifications of the mentioned smart card standards and platforms are included herein in their entirety by reference. The ISO organization has defined a smart card standard (ISO 7816), which is included herein in its entirety by reference.

The banks might be reluctant to carry the cost of providing a card reader to their smart card holders, when there is a very real risk that the same card reader could be used with a smart card from a competing bank. This would in essence give the competing bank a “free ride” and a competitive advantage because they did not have any costs to provide card readers. On the other hand, no single bank has any interest in going up against the industry standards, and build a proprietary system. Because a card issuer is left with little choice than to provide a card reader that can also be used to read cards from competitors, so far most card issuers have been reluctant to provide free card readers to their cardholders. If card issuer A provide a free card reader to his card holders, card issuer B might save the trouble and expense of providing a card reader and at least in part rely on the card holders to get their card readers from card issuer A or other card issuers. This will give card issuer B a competitive advantage and because of this risk so far most card issuers, particularly banks, have chosen a “wait and see” approach.

Demands

Demand for Card Issuers to Provide Card Readers to their Card Holders

There is a demand for card issuers to provide their cardholders with a card read/write device that comprises means for being coupled with a computer, to enable users to access data and applications stored on their cards.

Demand for the Card Reader to be Non-Proprietary

There is further a demand for the card issuers to provide card readers that are compliant with industry standards.

Demand for the Card Reader Provider to Control the use of the Readers

Even though there is a demand for the card issuers to provide a non-proprietary card reader, there is a demand from the card issuers (or the card reader providers) to control unauthorized use of the card readers they provide, to prevent competing card issuers from getting a “free ride”. There is a demand for the card reader provider to be able to exercise this control over the card reader even after the card reader has been installed at a users PC, thus enabling the card reader provider to later allow a user to use the card reader with a card from another card issuer.

Demand for the Card Issuer to have Part of the Cost Covered

If card issuers are to fully or partly finance card readers by the thousands, there is a demand for the card readers to be cheap and accordingly there is a demand for a solutions that makes it possible for the card issuers to get the cost covered—partly or fully.

### BACKGROUND—DESCRIPTION OF PRIOR RELATED ART

Smart Car Terminal Authorization Systems and Methods:

A number of authentication devices, systems and methods have been proposed in the prior art.

U.S. Pat. No. 4,961,142, et al.

U.S. Pat. No. 4 ,961,142 describes a multi-user transaction device with individual identification verification plug-in application modules for each issuer. The object of that invention is to provide transaction equipment for use with diverse personal transaction identification devices, each having different transaction format requirements. It is further an object of that invention to provide such equipment wherein the structure, programming and data used in security operations of the terminal for various issuing organizations is maintained under the separate control of each of issuing organization.

Disadvantages of U.S. Pat. No. 4,961,142

While the transaction terminal described in U.S. Pat. No. 4,961,142 can be used with different card systems from different card issuers, it has the serious drawback that it relies on physical modules to be attached or inserted into the terminal, one module for each card type. This solution is expensive for the card issuers, because it requires them to provide a module for each reader. Furthermore it is very impractical for a consumer to be required to make technical installations every time the terminal should be adapted to accept a new card type.

U.S. Pat. No. 6,226,744 B1, Murphy et al.

U.S. Pat. No. 6,226,744 B1 describes a method and apparatus for authenticating users on a network using a smart card. The object of that invention is to provide a system where a smart card is used to gain access to restricted information on a server, without the need for the user to have installed a smart card interface on a client terminal.

Disadvantages of U.S. Pat. No. 6,226,744 B1

While the invention described in U.S. Pat. No. 6,226,744 B1 provide a solution for restricting access to a web server using a smart card, it does not provide a solution for controlling what types of a smart cards will be accepted by the card reader. Furthermore, today smart card reader drivers are provided with common operating systems such as Windows 2000 and Windows XP thus eliminating the need for downloading an interface from a server to a client, which is a key ingredient in the invention described in U.S. Pat. No. 6,226,744 B1.

Other References

See the following U.S. Patents, each of which is incorporated herein by reference:

| Inventor | U.S. Pat. No. | Date | Title |
|---|---|---|---|
| Abecassis | 5,422,468 | 6-Jun-95 | Deposit authorization system |
| Ahvenainen | 6,199,161 | 6-Mar-01 | Management of authentication keys in a mobile |
| | | | communication system |
| Anderson, et al. | 4,186,871 | 5-Feb-80 | Transaction execution system with secure encryption key |
| | | | storage and communications |
| Austin | 4,935,962 | 19-Jun-90 | Method and system for authentication |
| Benson, et al. | 4,186,438 | 29-Jan-80 | Interactive enquiry system |
| Berstein | 4,558,211 | 10-Dec-85 | Transaction terminal system |
| Boston | 4,766,293 | 23-Aug-88 | Portable financial transaction card capable of authorizing a |
| | | | transaction in foreign currencies |
| Burger | 6,219,439 | 17-Apr-01 | Biometric authentication system |
| Creekmore | 4,187,498 | 5-Feb-80 | Check verification system |
| Davis, et al. | 6,088,450 | 11-Jul-00 | Authentication system based on periodic challenge/response |
| | | | protocol |
| Davis, et al. | 6,105,006 | 15-Aug-00 | Transaction authentication for 1-way wireless financial |
| | | | messaging units |
| Dillaway, et al. | 5,742,756 | 21-Apr-98 | System and method of using smart cards to perform security- |
| | | | critical operations requiring user authorization |
| Drake | 6,006,328 | 21-Dec-99 | Computer software authentication, protection, and security |
| | | | system |
| Eberhard | 5,473,689 | 5-Dec-95 | Method for authentication between two electronic devices |
| Elander, et al. | 4,500,750 | 19-Feb-85 | Cryptographic application for interbank verification |
| Elliott, et al. | 5,036,461 | 30-Jul-91 | Two-way authentication system between user's smart card and |
| | | | issuer-specific plug-in application modules in multi-issued |
| | | | transaction device |
| Ginter, et al. | 5,892,900 | 6-Apr-99 | Systems and methods for secure transaction management and |
| | | | electronic rights protection |
| Gray | 5,844,497 | 1-Dec-98 | Apparatus and method for providing an authentication system |
| Gray | 6,087,955 | 11-Jul-00 | Apparatus and method for providing an authentication system |
| Gray | 6,268,788 | 31-Jul-01 | Apparatus and method for providing an authentication system |
| | | | based on biometrics |
| Hackett, et al. | 6,182,894 | 6-Feb-01 | Systems and methods for authorizing a transaction card |
| Hekstra | 5,753,898 | 19-May-98 | Method for being capable of carrying out, with the same data |
| | | | carrier, various authentication processes, as well as system |
| Hiramatsu | 5,180,901 | 19-Jan-93 | IC card with individual authentication function |
| Hoffman, et al. | 5,613,012 | 18-Mar-97 | Tokenless identification system for authorization of electronic |
| | | | transactions and electronic transmissions |
| Hopkins | 5,757,918 | 26-May-98 | Method and apparatus for user and security device |
| | | | authentication |
| Iijima | 5,225,664 | 6-Jul-93 | Mutual authentication system |
| Iijima | 5,288,978 | 22-Feb-94 | Mutual authentication system and method which checks the |
| | | | authenticity of a device before transmitting authentication data |
| | | | to the device |
| Jewell | 4,891,503 | 2-Jan-90 | Distributed authorization system |
| Kawana | 4,697,072 | 29-Sep-87 | Identification card and authentication system therefor |
| Kawana | 4,746,788 | 24-May-88 | Identification system for authenticating both IC card and |
| | | | terminal |
| Kowalski | 6,152,367 | 28-Nov-00 | Wired logic microcircuit and authentication method having |
| | | | protection against fraudulent detection of a user secret code |
| | | | during authentication |
| Kowalski | 5,550,919 | 27-Aug-96 | Method and device for limiting the number of authentication |
| | | | operations of a chip card chip |
| Kowalski, et al. | 5,825,882 | 20-Oct-98 | Encryption and authentication method and circuit for |
| | | | synchronous smart card |
| Krajewski, et al. | 5,590,199 | 31-Dec-96 | Electronic information network user authentication and |
| | | | authorization system |
| Kruse, et al. | 4,786,790 | 22-Nov-88 | Data exchange system with authentication code comparator |
| Leighton, et al. | 5,351,302 | 27-Sep-94 | Method for authenticating objects identified by images or other |
| | | | identifying information |
| Marcus | 5,864,622 | 26-Jan-99 | Secure identification card and method and apparatus for |
| | | | producing and authenticating same |
| Molva, et al. | 5,347,580 | 13-Sep-94 | Authentication method and system with a smartcard |
| Muftic | 5,850,442 | 15-Dec-98 | Secure world wide electronic commerce over an open network |
| Murphy, et al. | 6,226,744 | 1-May-01 | Method and apparatus for authenticating users on a network |
| | | | using a smart card |
| Nakano, et al. | 4,727,244 | 23-Feb-88 | IC card system |
| Newby, et al. | 6,115,821 | 5-Sep-00 | Conditional access system, display of authorization status |
| Nishino, et al. | 5,857,024 | 5-Jan-99 | IC card and authentication method for information processing |
| | | | apparatus |
| Ogasawara, et al. | 5,097,115 | 17-Mar-92 | Transaction authentication system |
| Pascal, et al. | 6,055,638 | 25-Apr-00 | Process and authentication device for secured authentication |
| | | | between two terminals |
| Perlman, et al. | 6,173,400 | 9-Jan-01 | Methods and systems for establishing a shared secret using an |
| | | | authentication token |
| Rikuna | 4,827,113 | 2-May-89 | Technique for authenticating IC card and terminal |
| Smith | 4,731,842 | 15-Mar-88 | Security module for an electronic funds transfer system |
| Smith | 6,055,592 | 25-Apr-00 | Smart card authentication system comprising means for |
| | | | converting user identification and digital signature to pointing |
| | | | device position data and vice versa using... |
| Stark | 4,775,784 | 4-Oct-88 | Credit card imprinter authorization terminal |
| Van Tilburg, et al | 6,042,006 | 28-Mar-00 | Authentication system wherein definition signals of two |
| | | | devices are altered, communicated between the two devices, |
| | | | and compared |
| Veil | 6,138,239 | 24-Oct-00 | Method and system for authenticating and utilizing secure |
| | | | resources in a computer system |
| Watanabe | 4,709,136 | 24-Nov-87 | IC card reader/writer apparatus |
| Withrow | 6,116,505 | 12-Sep-00 | Fuel transaction system for enabling the purchase of fuel and |
| | | | non-fuel items on a single authorization |
| Yatsukawa | 6,148,404 | 14-Nov-00 | Authentication system using authentication information valid |
| | | | one-time |
| Yoshida | 4,709,137 | 24-Nov-87 | IC card and financial transaction processing system using IC |
| | | | card |
| Yoshimura | 6,126,071 | 3-Oct-00 | IC memory card system for authenticating an IC memory card, |
| | | | and IC memory card used for the same |
| Zeidler | 4,423,287 | 27-Dec-83 | End-to-end encryption system and method of operation |
| | 5,406,619 | 11-Apr-95 | Universal authentication device for use over telephone lines |

General Disadvantages of the Authentication Systems of the Prior Art

While the art referred to in the above mentioned references in some cases solve one or more of the previously discussed demands, the state of the art does not provide a solution device that solves all the discussed demands.

The authentication that is performed by systems and methods of the prior art are mostly performed by the smart card itself, by a computer to which the card reader is coupled, or by a server or a database over a network. Therefore there remains the need for a device, system and method to solve the discussed problems.

Objects, Summary and Advantages

Objects:

The objects of the present invention is:

A) To provide a card reader that can function as a non-proprietary card reader, while still allowing a card reader provider to control what cards and/or card types can be used in said card reader.

B) To provide a system and a method that allows the card reader provider to retain the control over the card types that the card reader will accept, even after the card reader has been distributed and installed on a user's computer.

C) To provide a system and a method that allows the card reader provider to partly or fully have the cost of providing the card reader covered either by the users or by other card issuers who wishes to make use of the infrastructure that the card reader provider has built by providing the card readers to the users.

Summary:

The invention is a card read/write device with a corresponding system and method that allows a provider of card readers to control exactly which cards and/or card types can be used in each individual card reader. A card reader is provided to a cardholder by card reader provider “A”. Said card reader does not have to be a proprietary system so the reader can comply with any industry standard, and be capable of reading many different types of smart cards.

For the sake of simplicity card reader provider “A” is also card issuer “A” in the following. It is conceivable that card issuer A is not the same company or entity as card reader provider “A”. In this case any cards from card issuer “A” would have to be authorized for use with the card readers provided by card reader provider “A”.

The card reader is equipped with a microprocessor and every smart card from card issuer “A” contains encrypted identification information that determines that the card was issued by card issuer “A”. The microprocessor in the card reader comprises an authorization unit that comprises means for storing data with information about which cards and/or card types (and from which card issuers and for how long etc.) the user is authorized to use with the card reader.

Card reader provider “A” can authorize that cards from other card issuers can be used in the readers provided by card reader provider “A”. If the request is made from the user, the card reader provider provides the user with instructions and means to update the authorization unit of the card reader.

If the request is made from a card issuer “B”, the card issuer “B” is provided with data that can be comprised in the card to enable the card reader to be updated.

When card reader provider “A” authorizes the use of a different card with their card reader, the non-volatile memory, which is comprised in the microprocessor of the card reader, is updated to reflect the latest addition.

In alternate embodiments of the present invention, the authorization data can conceivably be stored in alternate location than in the card reader itself. One such example is to store authorization information on a server, to which the card reader is coupled, for example over a network such as The Internet. In this particular embodiment, a connection is made to the source where the authorization information is stored, each time a card is inserted into the card reader.

Advantages:

From the description above a number of advantages of the present invention becomes evident. The general advantage of the present invention is, that it allows a card reader provider to provide card reader's that comply with the industry standards, while the card reader provider still retain control over exactly what cards can be used with the provided card reader. The present invention also provide a solution that creates a revenue model for card issuers, such as financial institutions that can potentially make it completely cost-less e.g. to a bank to provide a “free” card reader to their customers.

The specific advantages of the present invention are mentioned in the following:

A.

The present invention provides a solution that allows a card issuer or a card reader provider to provide a card reader and, a system and a method that complies with all industry standards, without said card issuer or card reader provider giving up control over what card and/or card types can be used with the provided card reader.

B.

The invention further provides a system and a method that allows a card reader provider to retain control over what cards and/or card types are used with the provided card reader, even after the card reader has been distributed and installed.

C.

A further advantage of the present invention, is that it provides a solution for a card reader provider to offer a user to be granted access to use an otherwise non-authorized card with the provided card reader.

D.

It provides a solution for card reader providers to authorize (or allow a card issuer to authorize) newly issued cards for use with the provided card reader, before the cards are distributed to users.

E.

Another advantage of the present invention is, that it provides a solution for a card reader provider to generate revenue on the card reader infrastructure that is build, thus providing an incentive for card issuers to also provide card readers as well.

F.

Yet another great advantage of the present invention is, that it eliminates the possibility of a second card issuer, relying on the card readers, which has been provided (and possibly paid for) by a first card issuer.

G.

Another advantage of the present invention is, that it provides a solution to break the gridlock that the smart card industry is finding itself in, in respect to the lack of smart card reader infrastructure and the enormous demand for such an infrastructure.

### DRAWINGS

### BRIEF DESCRIPTION OF THE DRAWING FIGURES

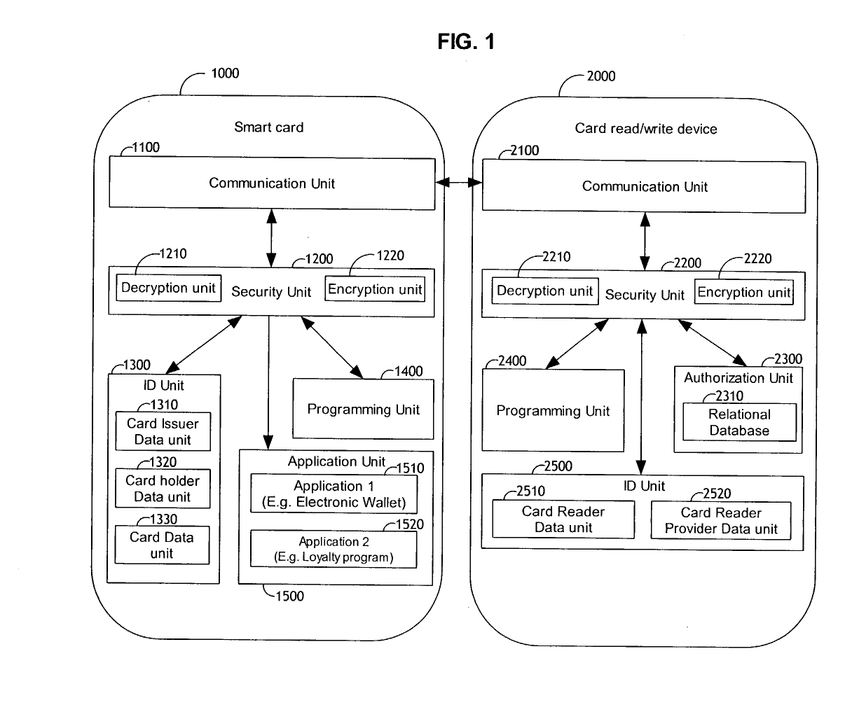

FIG. 1 is a schematic diagram showing a configuration of a system in which a card read/write device and an electronic storage device is communicating in accordance with one embodiment of the present invention.

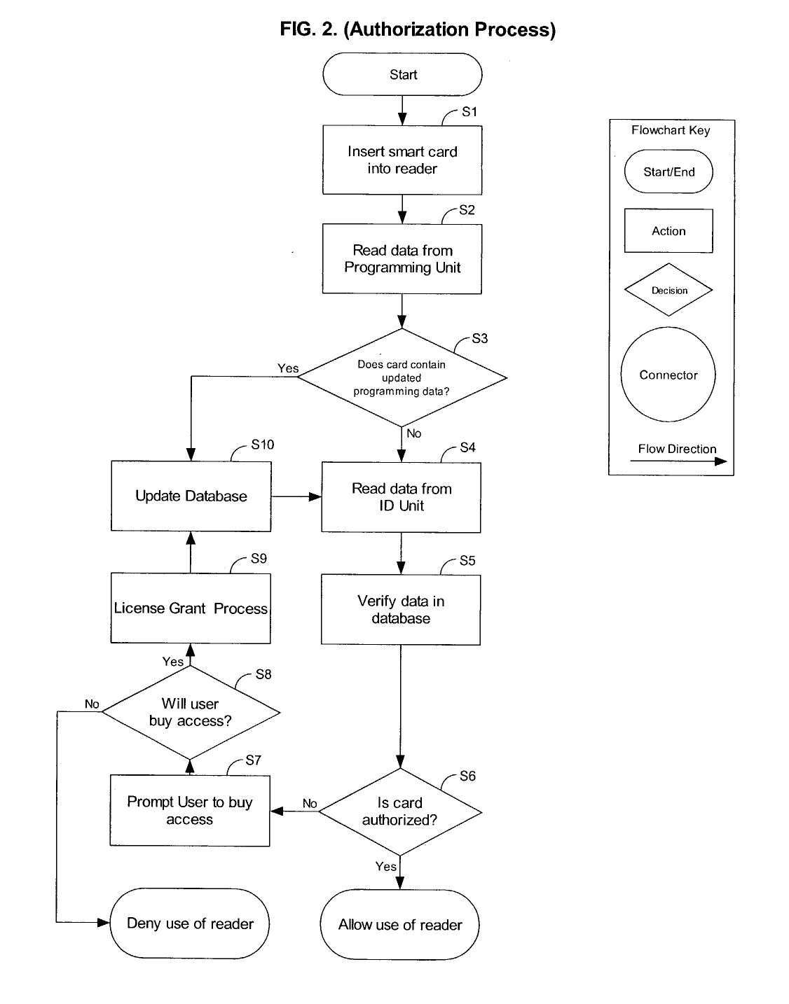

FIG. 2 is a flowchart illustrating a flow of the card authorization process of the present invention

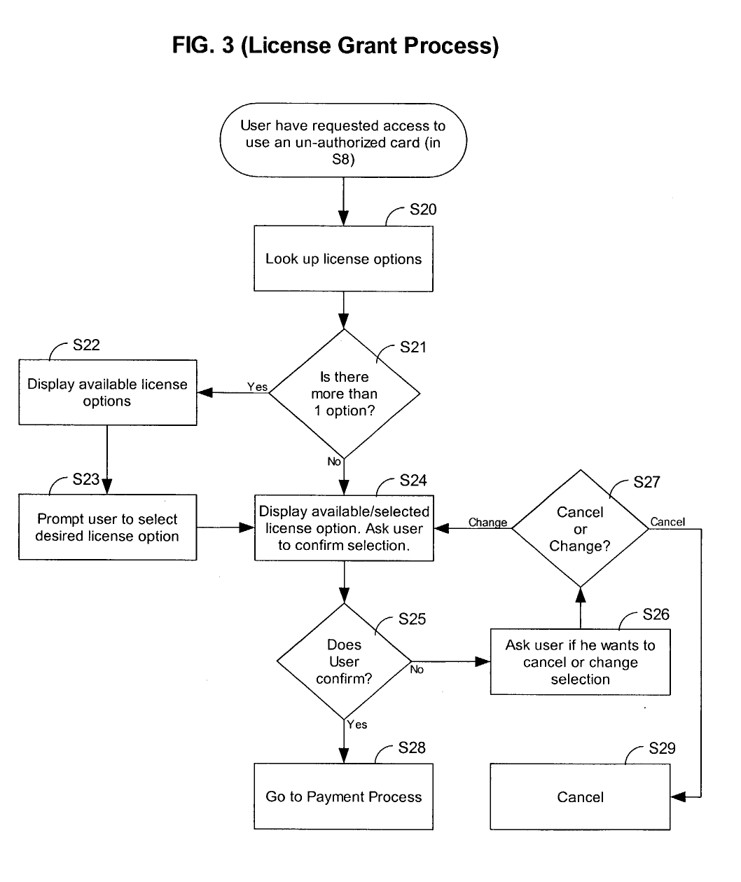

FIG. 3 is a flowchart illustrating a flow of the License Grant Process of the present invention

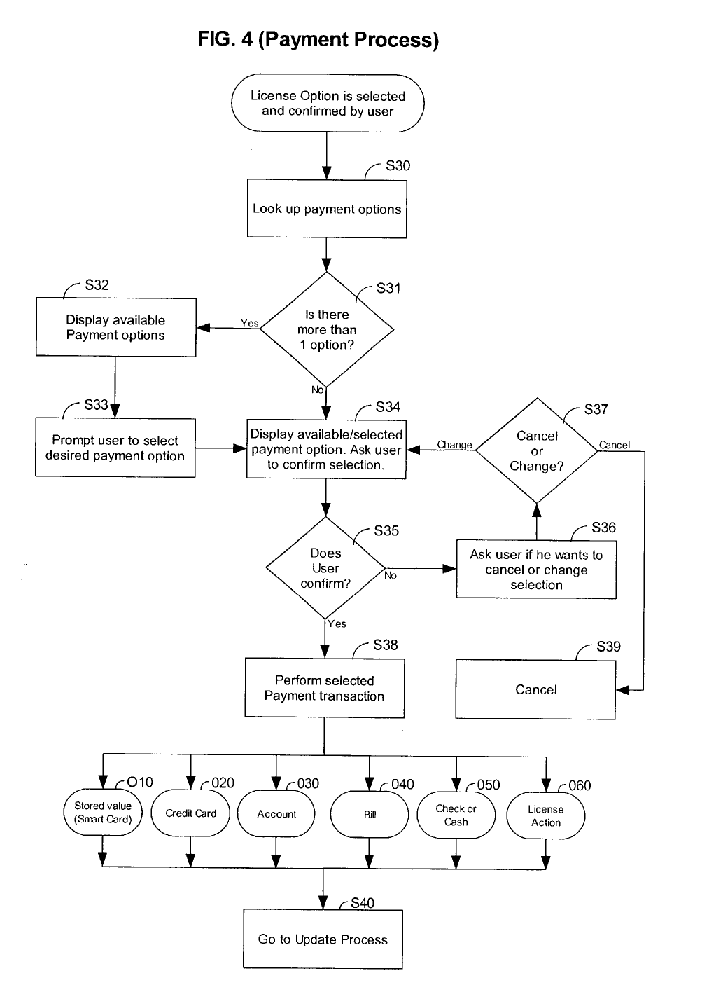

FIG. 4 is a flowchart illustrating a flow of the overall Payment Process of the present invention

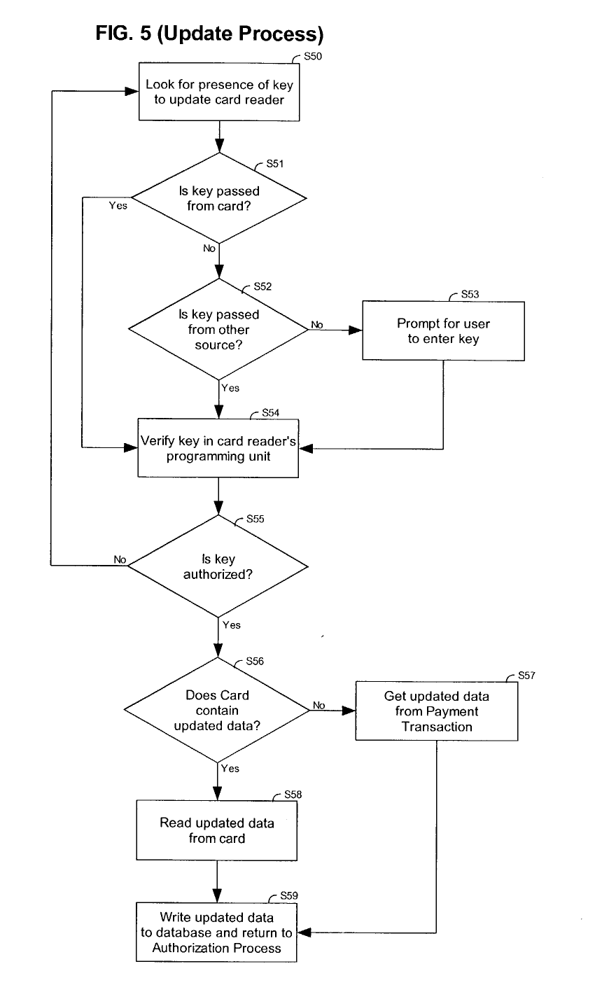

FIG. 5 is a flowchart illustrating a flow of the Card Reader Update process of the present invention

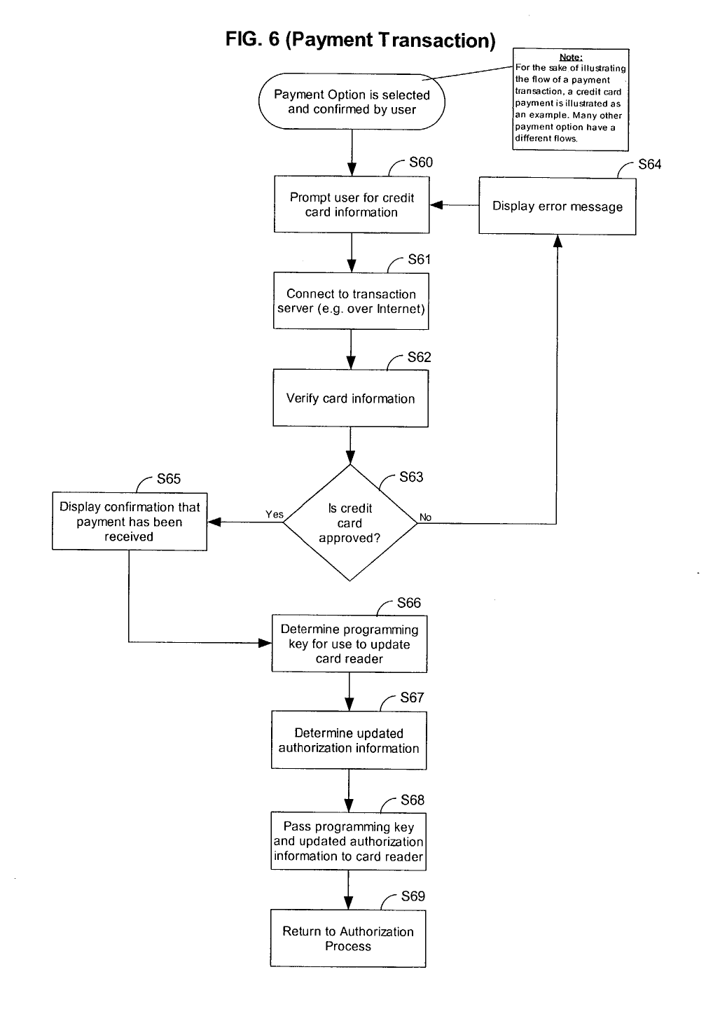

FIG. 6 is a flowchart illustrating a flow of the Payment Transaction process of the present invention

### REFERENCE NUMERALS IN DRAWINGS

FIG. 1.

1000 Smart card

1100 Communication unit of smart card 1000

1200 Security unit of smart card 1000

1210 Decryption unit of smart card 1000

1220 Encryption unit of smart card 1000

1300 ID unit of smart card 1000

1310 Card issuer data unit of smart card 1000

1320 Card holder data unit of smart card 1000

1330 Card data unit of smart card 1000

1400 Programming unit of smart card 1000

1500 Application unit of smart card 1000

1510 Application 1 of smart card 1000

1520 Application 2 of smart card 1000

2000 Card read/write device

2100 Communication unit of card reader 2000

2200 Security unit of card reader 2000

2210 Decryption unit of card reader 2000

2220 Encryption unit of card reader 2000

2300 Authorization unit of card reader 2000

2310 Relational database of card reader 2000

2400 Programming unit

2500 ID unit

2510 Card Reader Data unit

2520 Card Reader Provider data unit

FIG. 2.

S1 Step 1 of card authorization flowchart of FIG. 2

S2 Step 2 of card authorization flowchart of FIG. 2

S3 Step 3 of card authorization flowchart of FIG. 2

S4 Step 4 of card authorization flowchart of FIG. 2

S5 Step 5 of card authorization flowchart of FIG. 2

S6 Step 6 of card authorization flowchart of FIG. 2

S7 Step 7 of card authorization flowchart of FIG. 2

S8 Step 8 of card authorization flowchart of FIG. 2

S9 Step 9 of card authorization flowchart of FIG. 2

S10 Step 10 of card authorization flowchart of FIG. 2

FIG. 3.

S20 Step 20 of card authorization flowchart of FIG. 3

S21 Step 21 of card authorization flowchart of FIG. 3

S22 Step 22 of card authorization flowchart of FIG. 3

S23 Step 23 of card authorization flowchart of FIG. 3

S24 Step 24 of card authorization flowchart of FIG. 3

S25 Step 25 of card authorization flowchart of FIG. 3

S26 Step 26 of card authorization flowchart of FIG. 3

S27 Step 27 of card authorization flowchart of FIG. 3

S28 Step 28 of card authorization flowchart of FIG. 3

S29 Step 29 of card authorization flowchart of FIG. 3

FIG. 4.

S30 Step 30 of card authorization flowchart of FIG. 4

S31 Step 31 of card authorization flowchart of FIG. 4

S32 Step 32 of card authorization flowchart of FIG. 4

S33 Step 33 of card authorization flowchart of FIG. 4

S34 Step 34 of card authorization flowchart of FIG. 4

S35 Step 35 of card authorization flowchart of FIG. 4

S36 Step 36 of card authorization flowchart of FIG. 4

S37 Step 37 of card authorization flowchart of FIG. 4

S38 Step 38 of card authorization flowchart of FIG. 4

S39 Step 39 of card authorization flowchart of FIG. 4

S40 Step 40 of card authorization flowchart of FIG. 4

O10 Option 10 of the payment process of the flowchart of FIG. 4

O20 Option 20 of the payment process of the flowchart of FIG. 4

O30 Option 30 of the payment process of the flowchart of FIG. 4

O40 Option 40 of the payment process of the flowchart of FIG. 4

O50 Option 50 of the payment process of the flowchart of FIG. 4

O60 Option 60 of the payment process of the flowchart of FIG. 4

FIG. 5.

S50 Step 50 of card authorization flowchart of FIG. 5

S51 Step 51 of card authorization flowchart of FIG. 5

S52 Step 52 of card authorization flowchart of FIG. 5

S53 Step 53 of card authorization flowchart of FIG. 5

S54 Step 54 of card authorization flowchart of FIG. 5

S55 Step 55 of card authorization flowchart of FIG. 5

S56 Step 56 of card authorization flowchart of FIG. 5

S57 Step 57 of card authorization flowchart of FIG. 5

S58 Step 58 of card authorization flowchart of FIG. 5

S59 Step 59 of card authorization flowchart of FIG. 5

FIG. 6.

S60 Step 60 of card authorization flowchart of FIG. 6

S61 Step 61 of card authorization flowchart of FIG. 6

S62 Step 62 of card authorization flowchart of FIG. 6

S63 Step 63 of card authorization flowchart of FIG. 6

S64 Step 64 of card authorization flowchart of FIG. 6

S65 Step 65 of card authorization flowchart of FIG. 6

S66 Step 66 of card authorization flowchart of FIG. 6

S67 Step 67 of card authorization flowchart of FIG. 6

S68 Step 68 of card authorization flowchart of FIG. 6

### DETAILED DESCRIPTION OF THE PREFERRED EMBODIMENTS

In various embodiments of the present invention, described in enabling detail below, a card reader, system and method is provided, wherein authorization information is stored in a card reader, for authorization of each card that is inserted into the card reader. The authorization data in the card reader can be updated in a plurality of ways.

If a user inserts a card that is not authorized into the reader, he can optionally be offered the option to be granted access to use the reader with that particular card (and possibly other cards) by paying a fee, or by performing other actions (in the following referred to as License grant Actions), as determined by the card reader provider.

A few examples of such License Grant Actions that a user optionally could be required to perform to get access to use a non-authorized card the card reader includes (but are by no means limited to) the purchase of certain products or services, the purchase of products or services over a certain amount, signing up for an account (banks, brokers etc.), joining an organization, donating to certain charities, visit websites, answering questionnaires, playing certain online or offline games (or reaching a certain level in a game), solve a quiz, signing up for a loyalty program, downloading certain programs or material, installing certain programs on a computer, participating in a meeting, participate in a survey. If the user decides to pay a fee—or perform other satisfactory actions as discussed above, the authorization information in the card reader is updated accordingly, and access to use the card reader is granted. If the user opts not to pay a fee or perform other satisfactory actions, access to use the card reader with a particular card is denied.

FIG. 1—Schematic Diagram

FIG. 1 is a schematic diagram that illustrates a preferred embodiment of a system according to the present invention that comprises a smart card and a card reader. Each element of the smart card and of the reader is further described in the following:

Smart Card 1000

A smart card 1000 according to the preferred embodiment of the present invention comprises:

A. A communication unit 1100;

B. A security unit 1200 that comprises an encryption unit 1210 and a decryption unit 1220;

C. An ID unit that comprises a card issuer data unit 1310, a card holder data unit 1320 and a card data unit 1330:

D. A programming unit 1400;

E. An application unit 1500 that comprises at least one application 1510.

A description of each unit of the smart card is included in the following:

A. The Communication Unit 1100

The communication unit of the card 1100 comprises means for communicating with the communication unit 2100 of the card reader 2000. In the preferred embodiment of the invention, the communication between the card and the card reader is done by establishing a connection between a contact pad comprised on the surface of the smart card and a contact element comprised on the card reader. Such connection between the contact pad of the card and the contact elements of the card reader is established by inserting the smart card into a card insertion slot comprised in the card reader.

In other embodiments of the invention, other means of communication can be utilized, depending on what type of card is used. A contact-less smart card communicates with the corresponding card reader using wireless means of communication (and the card is not inserted into a card insertion slot, but held close to the reader), a magnetic stripe card communicates with a corresponding magnetic stripe card reader etc.

In yet another embodiment of the present invention, a smart card is equipped with 2 contact pads, one of which is used to program the card reader, the other used for other purposes.

The prior art describes numerous ways of establishing communication between a card and a card reader, all of which can be used with the present invention.

B. The Security Unit 1200

In the preferred embodiment of the present invention the security unit of the smart card 1200 is used for encrypting and decrypting sensitive information. When a card is inserted into the card reader—or by other means coupled to the card reader, the security unit 1200 can optionally cause the user to be prompted to enter a Personal Identification Number (PIN). In the preferred embodiment of the present invention, the card reader is compliant with the FINREAD specifications, and thus the reader comprises a keypad to allow a user to enter a PIN directly into the card reader, without the use of a computer keyboard.

The security unit then uses the decryption unit 1220 to decrypt the encrypted PIN information stored in the card data unit 1330, and performs a comparison between the entered PIN and the PIN stored on the card. Only if the 2 PINs match, the authorization process is allowed to continue.

In alternate embodiments of the present invention, the PIN is not required and in yet another embodiment of the present invention it is conceivable that the card reader is not equipped with a keypad, but for example requires the user to enter a PIN using a computer keyboard.

C. The ID Unit 1300

According to the preferred embodiment of the present invention, every card must comprise identification information that is used to determine whether or not a card is authorized for use with a particular card reader. An Answer To Reset command is send to the card, which in turn replies with the cards identification information. The ISO 7816 standard describes one suitable card identification system for use with the present invention. Other card identification systems could also be used with the present invention.

Certain data comprised in the ID unit 1300 of the smart card 1000 must meet certain criteria stored in the database 2310 of the card reader's authorization unit 2300, for a successful authorization to take place. Which specific criteria that must be met in order for a particular card to be authorized for use with a particular card reader, is determined by the card reader provider and/or the card issuer.

C.1. The Card Issuer Data Unit 1310

In the preferred embodiment of the present invention, the ID unit comprises a card issuer data unit, which comprises data used to identify the card issuer. The Card Issuer (CI) data unit comprises at least one of the following fields:

CI ID number

CI name

CI street1

CI street2

CI city

CI zip

CI state

CI country

CI corporate phone number

CI corporate fax number

CI corporate website

CI corporate email address

CI support phone number

CI support fax number

CI support website

CI support email address

CI promotional website

The data in the Card Issuer data unit can be stored in either un-encrypted or encrypted form.

In another embodiment of the present invention, the Card Issuer data unit comprises additional—or other fields, and in yet another embodiment the need for the ID Unit of a smart card to comprise a Card Issuer data unit can conceivably be eliminated.

C.2. The Card Holder Data Unit 1320

In the preferred embodiment of the present invention, the Card Holder (CH) data unit comprises at least one of the following fields:

CH ID number

CH company ID number

CH company name

CH name

CH title

CH street1

CH street2

CH city

CH zip

CH state

CH country

CH private phone number

CH private fax number

CI private website

CI private email address

CI cell phone number

CI fingerprint image

CI head shape image

CI other biometric information (such as voice pattern or DNA information)

CI birth date

CI social security number

Other Useful Information

The data in the Card Holder data unit can be stored in either un-encrypted or encrypted format.

In another embodiment of the present invention, the Card Holder data unit comprises additional—or other fields, and in yet another embodiment the need for the ID Unit of a smart card to comprise a Card Holder data unit can conceivably be eliminated.

C.3. The Card Data Unit 1330

In the preferred embodiment of the present invention, the Card data unit comprises at least one of the following fields:

Card ID number

Card expiration date

User PIN code (for accessing the card)

Admin PIN code (for programming the card)

User's security level (is he authorized to update the card etc.)

Card's security level (is a PIN needed to access the card, is BOTH a PIN and a fingerprint match needed etc.)

License information (information about limits in the number of uses or other license restrictions)

The data in the Card data unit can be stored in either un-encrypted or encrypted format.

In another embodiment of the present invention, the Card data unit comprises additional—or other fields, and in yet another embodiment the need for the ID Unit of a smart card to comprise a Card data unit can conceivably be eliminated.

D. The Programming Unit 1400

The programming unit 1400 is used to re-program—or update information comprised the smart card reader. Optionally it is conceivable that the programming unit 1400 could also be used when re-programming or updating information on a smart card.

E. The Application Unit 1500

In the preferred embodiment of the present invention, at least one of the following applications is provided on the smart card 1000 and stored in the application unit 1500:

Secure credit

Stored value

Electronic wallet

Insurance (such as proof of insurance and insurance records)

Medical records

Drivers license

Driving record

Electronic Tickets (such as public transit tickets, sports—and cultural events etc.)

Loyalty (such as frequent flyer programs, repeat customer awards, bonus programs etc.)

Electronic coupons (for example for shopping purposes)

Identification

Donor information (such as blood or organs)

PIN and/or password holder

A card issuer and the capacity of the card determines if more than one application is provided on the card. The present invention can be used with any application that can be stored on a card, and not only the few examples mentioned above. Similarly multi-application cards comprising any combination of applications can be used with the card reader, system and method of the present invention.

Card Reader 2000

A card reader according to the preferred embodiment of the invention comprises:

A. A Communication unit 2100;

B. A Security unit 2200 that comprises an encryption unit 2210 and a decryption unit 2220;

C. An Authorization unit 2300 that comprises a “Positive list Database” 2310;

D. A Programming unit 2400;

E. An ID unit that comprises a “card reader data unit” 2510 and a “card reader provider data unit” 2520;

A description of each unit of the card reader is included in the following:

A. The Communication Unit 2100

The communication unit of the card reader 2100 comprises means for communicating with the communication unit of the card 1100. In the preferred embodiment of the invention the communication between the card and the card reader is done through establishing a physical connection between a contact pad comprised on the surface of the smart card and a contact element comprised on the card reader. Such physical connection between the contact pad of the card and the contact elements of the card reader is established by inserting the smart card into a card insertion slot comprised in the card reader.

In other embodiments of the invention, other means of communication can be utilized, depending on what type of card is used, as further described above under the description of the communication unit 1100.

B. The Security Unit 2200

In the preferred embodiment of the present invention the security unit of the card reader 2200 is used for decrypting encrypted data that is received from other sources or stored in other units of the card reader. Similarly the security unit is used for encrypting data before remitting it to other sources or before storing it in other units of the card reader.

C. The Authorization Unit 2300

In the preferred embodiment of the present invention, the authorization unit comprises a non-volatile memory (such as a database) wherein data is stored that is used to match data received from an ID unit 1330 of a smart card 1000. In alternate embodiments the authorization data is received from other sources than a smart card, such as directly through the Internet or from computer software applications.

The files and the fields of the non-volatile memory of the preferred embodiment of the present invention are:

Database File: Card Types

Card type ID

Card type name

Card issuer ID

Is card type allowed (yes/no)

Expiration date for card type

Card type license ID

Database File: Card Issuers

Card issuer ID

Card issuer name

Is card issuer allowed (yes/no)

Expiration date for card issuer

Card issuer license ID

Database File: Card Holders

Card Holder ID

Card Holder name

License ID

Database File: Card Holder Preferred Payment Method

Card Holder ID

Preferred Payment method

Database file: Card Holder Payment Options

Payment Option ID

Payment Option Description

Options (examples):

1. Credit card

2. Stored value card

3. Check

4. Credit an account

5. Money transfer

6. Online payment (such as Pay Pal etc.)

7. Credit phone bill

8. Credit other regular bill (such as Electrical bills, DirecTV, AOL, Magazine subscriptions, Internet subscriptions (such as those proposed according to Microsoft's proposed Net strategy) or Internet access)

9. Credit cell phone bill

10. Credit pre-paid cell phone card

11. Credit prepaid phone card

12. Cash (at participating merchants or banks)

Database File: Card Holder Credit Cards

Card Holder ID

Credit card type ID

Expiration date

Credit card number

Database File: Card Holder Account Information

Card Holder ID

Account type

Financial institution ID

Account number

Database File: Card Holder Billing Information

Card Holder ID

Bill type

Bill issuer

Database File: Financial Institutions

Financial institution ID

Financial institution name

Financial institution SWIFT code

Other information about the institution (such as address, website etc.)

Database File: License Information

License ID

Apply to card types

Apply to card issuers

Number of allowed uses

Number of uses left

Allowed period begin

Allowed period end

D. The Programming Unit 2400

Database File: Admin Security Level

Are user allowed to change security settings (yes/no)

Admin Security level ID

Database File: Possible Admin Security Levels

Admin Security level ID

Admin Privilege Code

Database File: Admin Privilege Codes

Admin Privilege Code

Privilege Description

Options (examples):

1. No restrictions

2. Must provide PIN (or other input key)

3. Must provide PIN OR Biometric authentication

4. Must provide PIN AND Biometric authentication

5. Must provide Biometric authentication

6. Must have physical card with specific card ID present

7. Must have specific card ID present AND provide PIN

8. Must have specific card ID present AND provide PIN AND biometric authentication

Database File: Allowed Admin ID Numbers

Admin ID number

Database File: Admin ID

Admin ID number

Admin name

Admin PIN code

Registered Admin Card ID

Biometric info (such as unique identification information using fingerprint, head shape, DNA, Iris or Voice etc.)

E. The ID Unit 2500

In the preferred embodiment of the present invention, the ID unit 2500 of the card reader 2000 comprises an ID unit, which comprises data related to the card reader and the card reader provider. The ID unit comprises at least one of the following fields:

E.1. Card Reader Data Unit 2510

Card reader ID number

Card reader provider ID

Card reader manufacture code

Card reader manufacture date

Card reader Serial number

Card reader Model Identification

E.2. Card Reader Provider Data Unit 2520

Card reader provider ID

Card reader provider name

Other embodiments of the present invention require less memory space in the card and the reader, by reducing the number of files and/or fields in the database.

Another embodiment of the present invention does not require the use of a relational database, but stores authorization information in the code of the programming unit 2400 of the card reader or in the programming unit 1400 of the card.

A simplified example of such code module (in pseudo code) is illustrated in the following:

| 0. | Private Sub CheckCard ( ) | | |
|---|---|---|---|
| 1. | X = 3 | | |
| 2. | AuthorizedCardIssuerID = Array(“American Express”, “Visa”, “Mastercard”) | | |
| 3. | LicenseExpirationDates = Array(010102, 010102, 010102) | | |
| 4. | | | |
| 5. | NumberOfAuthorizedCards = X | | |
| 6. | AccessGranted = False | | |
| 7. | | | |
| 8. | For CycleCount = 1 to X | | |
| 9. | | If UserCard.CardIssuerID = AuthorizedCardIssuerID(CycleCount) and _ | |
| 10. | | | UserCard.CardExpirationDate >= LicenseExpirationDates(CycleCount) then |
| 11. | | | AccessGranted = true |
| 12. | | | Exit For |

| | |
|---|---|
| 13. | End if |

| | |
|---|---|
| 14. | Next CycleCount |
| 15. | End Sub |

If for example a new card issuer must be added to the list of authorized card issuers, the programming unit would only need to correct the value of X in line 1., append the new AuthorizedCardIssuerID to the string in line 2., and append the corresponding LicenseExpirationDate (if any) in line 3.

FIG. 2—Flowchart for Card Authorization Check

FIG. 2 is a flowchart illustrating a flow of the overall authorization system of the preferred embodiment of the present invention.

Step 1—Insert Card into Reader

A user inserts a smart card into the card insertion slot. The card reader comprises detecting means for detecting when the card is correctly inserted into—or otherwise coupled to the card reader, and ready for communication. Numerous of such detecting means are described in the prior art.

In alternate embodiments of the present invention, other types of cards can be used, for example magnetic stripe cards. Similarly any other portable electronic storage media technology can be used with the present invention.

If contact-less technologies are used, such as a contact-less smart card, the need for a card insertion slot is eliminated, and the card is not inserted into such a slot, but held close enough to the read/write device to establish communication between the portable storage media and the read/write device.

Step 2 and Step 3—Read Data from Programming Unit 1400

When a card is detected, the reader 2000 communicates with the programming unit 1400 on the smart card 1000 to check if the programming unit on the card comprises updated information that should be programmed into the reader before further authorization steps is performed.

This provides a solution for card reader providers to allow card issuers to include a programming unit in the cards, to program the readers and update the authorization unit 2300 to allow the use of the card.

The data in the programming unit 1400 are encrypted in order to avoid non-authorized cards access to update the card reader with non-authorized information.

Step 3 determines if the card comprises updated programming information. If it does, the Update Database procedure is called (Step 10).

If the card does not comprise updated programming information, the next step in the authorization process is called (Step 4).

Step 4—Read Data from ID Unit 1300 on Smart Card 1000

After the non-volatile memory has been updated in Step 10, or it has been established in Step 3 that the inserted card 1000 does not contain any information that should be updated in the card reader 2000, data is read from the ID unit 1300 of the smart card 1000.

Step 5—Compare Data from ID Unit 1300 on Smart Card 1000 with Database Unit 2300 in Card Reader 2000

The data that is read from the ID unit 1300 of the smart card 1000, must match certain criteria defined in the database unit 2300 of the card reader 2000, in order for use of the reader to be authorized. The card reader provider can determine what—and how many criteria must be met, for the card reader to be authorized for use.

Step 6—Determine if Card 1000 is Authorized for Use in Card Reader 2000

In the preferred embodiment of the present invention, the Card Issuer ID is looked up in the Card Issuer Data unit 1310 of the smart card 1000. A search is then performed in the Authorization unit, to establish if the Card Issuer ID of the card, is included in the “positive list” in the database unit 2300 that comprises all the unique ID codes of the Card Issuer's whose cards is authorized to be used with the card reader.

Depending on the criteria defined by the card reader provider, a plurality of other information such as expiration date and Personal Identification Numbers can be read from the card 1000 and be required to meet criteria defined in the database unit 2310 of the card reader.

Step 7—Offer Users a Way to be Granted Access to Use Card Reader

If the information read from the card in Step 6 does not meet the defined criteria, the card reader is not authorized to be used with the inserted card. In the preferred embodiment of the present invention, the user will then be presented with an option to pay a fee, or perform a predetermined action such as making a purchase, signing up for a new account or joining an organization etc.. In Step 7 the user can either accept to pay a fee (or otherwise satisfy the card reader provider and/or card issuer), or he can opt not to pay such fee.

Step 8—Determine if User Wishes to be Granted Access to Use Card Reader

When the user input a reply in Step 7, it is determined if the authorization process should be called, or if use of the card reader 2000 should be denied.

Step 9—Go through License Grant Process

Every card reader provider, determine their own individual grant process and what steps such process involve. The grant process of the preferred embodiment of the present invention involves the following steps:

Step22—Provide information regarding the License Grant Process, the different options and the requirements to meet each option.

Step 23—Determine preferred (or available) license option

Step 33—Determine preferred (or available) payment option

Step 65—Receive payment from user (or proof that other satisfactory action has been taken) (see FIG. 4)

Step 68—Provide user with means to update the authorization unit of the card reader, to append the newly authorized card to the list of authorized cards.

Step 69—Return user to Authorization

A flowchart of the License Grant Process (Step 9) is illustrated in FIG. 3 and described in further detail in the following.

Step 10—Update Data

If the user in Step 8 opts to go through the License Grant Process (Step 9), means is provided to the user after successful completion of the License Grant Process of Step 9, to allow the user to update the card reader according to the granted use of the reader. One example of such means is to allow the user to download an application from the Internet, having means to update the authorization unit of the card reader. There are many conceivable update processes, and any conceivable update process, procedure and method can be used with the present invention.

An update process of a preferred embodiment of the present invention is illustrated in the flowchart of FIG. 5. and described in further detail in the following.

FIG. 3. License Grant Process

Steps 20-29—Determine Desired/Available License Option

In the preferred embodiment of he present invention, the card reader comprises means for storing different license options in the authorization unit. When a user requests to be granted access to use a specific card with the card reader, the user is presented with the different available license options. If there is more than one license option, the user is prompted to select the preferred license option.

It is conceivable that the license options are stored in other sources than the card reader, for example on a smart card, on a diskette or a CD, on a computer or on a server over a network. In these cases, a connection is first established to the relevant source comprising the license options, before the options are presented to the user.

When the desired license option has been established, the Payment Process (FIG. 4) is called.

FIG. 4. Payment Process

Steps 30-39—Determine Desired/Available Payment Option

In the preferred embodiment of he present invention, the card reader comprises means for storing different payment options in the authorization unit. When a user requests to be granted access to use a specific card with the card reader, the user is first presented with the different available license options. Once it has been determined what license option is selected by—or available to the user, the user is prompted to select the preferred payment option.

It is conceivable that the payment options are stored in other sources than the card reader, for example on a smart card, a diskette or a CD, on a computer or on a server over a network. In these cases, a connection is first established to the relevant source comprising the payment options, before the options are presented to the user.

When the desired payment option has been established, the Payment Transaction Process (FIG. 6) is called.

FIG. 5. Update Process

Step 50-59—Determine if Programming Key is Present—and if so, Update Card Reader

In the preferred embodiment of the present invention, the card reader comprises means for repeatedly storing updated authorization data. To gain access to re-program the card reader, a data key (or conceivably a physical key) must be present. When an attempt is made to update the card reader, it is first determined if a key is present. Such a key can either be passed to the Update Process from other processes (such as the Payment Transaction Process), or it can be present on other sources, for example a smart card, a diskette or ad CD, or on a server over a network (such as the Internet).

When a key is presented to the card reader, it is verified in the programming unit of the card reader, and if programming access is approved, the updated data is then read to the card reader. The updated information can come from any approved data source, and the programming unit of the card reader can be configured to regularly perform an automatic update, for example by logging into a card reader provider's server over a network, such as The Internet, and retrieving updated login information.

FIG. 6. Payment Transaction Process

When a payment option has been determined and confirmed in Step 35 of the Payment Process (FIG. 4) a payment transaction is performed depending on the selected payment option. FIG. 6 illustrates one example of such a payment transaction, which is a credit card transaction.

Step 60-69

The user is first prompted to enter the relevant credit card information. When the desired information is entered, a connection is established to a transaction server over a network (for example the Internet), and the card information is then verified at the transaction server. If the card is approved, the credit card is credited and a programming key and updated authorization information is provided to the user (or passed directly to the card reader) for use when updating the card reader to reflect the recent changes.

Conclusion, Ramifications and Scope

Conclusion

Thus it can be seen that I have provided a system and method for controlling the use of a card read/write device with the following advantages:

The ability for a card reader provider to provide a card reader and a system and a method that complies with all industry standards, without said card issuer or card reader provider giving up control over what card and/or card types can be used with the provided card reader.

The ability to retain control over what cards and/or card types are used with the provided card reader, even after the card reader has been distributed and installed.

The ability for a user to get an, otherwise un-authorized, card authorized for use with a provided card reader.

The ability for a card reader provider to authorize (or allow a card issuer to authorize) newly issued cards for use with the provided card reader, before the cards are distributed to users.

The ability for card reader providers, to generate revenues from an item, which would normally be a cost to them.

The ability to discourage other card issuers to rely on unauthorized use of a card reader provided by another card issuer.

The ability to break the gridlock that the smart card industry is finding itself in, in respect to the lack of smart card reader infrastructure.

Ramifications

While the invention has been described with respect to several preferred embodiments, it will be appreciated that they are set forth purely for purposes of examples, and that many other variations, modifications and applications of the invention may be made. A few possible ramifications are mentioned in the following:

Other Media Types

The preferred embodiment of the present invention describes the use of a smart card and a smart card reader. It is understood that other embodiments of the present invention easily can be adapted to work equally well on any other type of electronic storage media and any devices capable of reading such electronic storage media. Some examples of the conceivable media types are (but by no means limited to):

a bar code card

a CD-ROM

a citizen card

A Compact Disc

a Compact Flash card

a contact smart card

a contact-less smart card

a DVD rom

a floppy disk

a hard disk

a loyalty program card

a magnetic strip card

a memory chip

a memory module

a memory stick

a mini disk

a payment card

a phone card

a RAM module

a RAM module

a Smart Media card

a stored value card

A tape

a Zip disk

an access card

an election card

an electronic book

an identification card

Different Industries

The scope of the present invention is not limited to any industry. Any industry or entity that could potentially benefit from the advantages of the present invention, and it can be adapted for use in any industry. For the sake of illustration, a few examples are mentioned in the following:

Loyalty Programs

A first retailer that is issuing smart cards and provide free smart card readers to its customers, have a need to ensure that other retailers does not uncontrollably rely on having their customers use the card reader provided by the first retailer. Similar concerns apply to any other loyalty program, regardless of what industry it is in.

Banking

When a bank provide a smart card and a card reader, for example to facilitate a shift to “do-it-yourself” online banking, they are facing a big investment in the smart cards, and particularly in the card readers. There is a great demand for a card reader providing bank to control what cards can be used in the provided card reader.

Internet Payments

A website or a web-merchant that provide cards and card readers to it's customers, for example to enable its customers to make micro-payments over the Internet, have a great interest in controlling what cards from other competing websites or merchants can be used in the provided card readers.

Software Copy Protection

It is conceivable that software manufacturers (such as Microsoft, Adobe and others) in the near future begin to bundle free smart card readers and a smart card with every software product they sell. By requiring the presence of a smart card in order for a user to use the software, the software manufacturer can effectively put an end to illegal software piracy. A first software manufacturers, that is providing card readers to its customers, have a great need to prevent other software manufacturers from simply issuing a smart card and relying on the free use of the card reader provided by the first software manufacturer.

Gambling and Lotteries

On- and offline casinos and/or lotteries that provides cards and card readers to it's players have a demand to ensure that other game provider's cards are not used in the provided card reader, without the authorization of the card reader provider.

Smart Cards

Any type of smart card can be used with the present invention, and not only those that comprise a microprocessor as described in the preferred embodiment of the invention. In the schematic diagram of FIGS. 1, 2 applications are comprised in the application unit of the smart card. This is merely for the sake of example. Any number of applications can be stored on the smart card, and still fall within the scope of the present invention.

Multiple Cards

In alternate embodiments of the present invention, the card reader comprises means for coupling to a plurality of portable electronic storage devices. One example is 2 IC card insertion slots, where one card insertion slot can be used to permanently hold a payment smart card, and the other card insertion slot used for various application cards.

Alternate Embodiment

Although not described in the preferred embodiment of the present invention, a card reader of an alternate embodiment of the invention further comprises an application unit, for example an electronic wallet application.

Upon manufacture, purchase or issue (or during any other point during the lifespan of the card reader) a value can be stored in the application unit, and used as payment of License Fees. Other applications can conceivably be stored in an application unit in the card reader.

Collection of Fees

There are numerous ways for a card reader provider to collect license fees. Although only a few is mentioned in the description, it is appreciated that any fee collection system can be used within the scope of the present invention. One such fee collection system is described in U.S. Pat. No. 6,321,213 B1.

Proprietary Systems

Although the preferred embodiment of the present invention provides a solution for a card reader provider to provide a card reader that comply with industry standards, while still allowing the card reader provider to control what cards are used with the card reader, other embodiments of the invention, can optionally comprise a non-standard (or proprietary) card reader. Similarly alternate embodiments of the inventions can make use of proprietary card systems.

Different Architectures

The preferred embodiment of the present invention describes one possible architecture that can be used with a card and a card reader of the invention. Any other architecture can be used with the invention, for example could a PIN code verification take place in a Security unit instead of a Programming unit and so on. It is entirely up to each card reader provider to determine the exact desired architecture.

Control Passed On

A card reader provider can of course decide to pass on the privilege of controlling the use of the card readers to other companies or service providers.

License Options

Although a plurality of different license options is mentioned in the preceding, it is up to the card reader provider to decide which options should be made available to a user. A card reader provider can conceivably decide that a fee must be collected every single time a card is to be used in the card reader, or a card reader provider may decide to charge a small onetime fee for unlimited and unrestricted use of the card reader.

Periodic Automatic Update of Reader

In alternate embodiments of the invention, the reader comprises means for periodically and automatically connecting to an “update server” over a network, to update the latest authorization information from the card reader provider. In one such alternate embodiment, the reader comprises an update unit, that stores information about the last update, and when the next scheduled update should take place. How often a reader is updated, is determined by the card reader provider, who in turn can opt to allow the user to control how often the reader connects to the update server. This particular embodiment of the invention is useful if, for example, a card issuer pays a collective license fee on behalf of all its cardholders. When a cardholder inserts a card from said card issuer, the card reader has already updated (provided is has been updated regularly as outlined above), and thus the card is authorized instantly when inserted (or otherwise coupled) to the reader.

Update Information

Updated data to be stored in the card reader can be provided to the user in a plurality of ways. An obvious way is to provide the information on a smart card, but said information could be passed to the card reader from any other media, such as a diskette, a CD-ROM, directly from a server over the internet, from a software application on a computer etc. Any means for providing the updated authorization data to the card reader falls within the scope of the present invention. Similarly any information that is displayed to the user during any process of the present invention can come from any number of sources.

Storage of Authorization Data

The authorization data can be stored in any non-volatile memory in the card reader or on any device that the card reader can be coupled to. The data can be stored in any form, encrypted or un-encrypted. The authorization data can optionally be stored in a database or a relational database.

Online Authorization

Instead of storing authorization data in the card reader, the data can conceivably be looked up in different sources each time an authorization is required. One example is to store the authorization data on a network server, that the card reader can be coupled to, to perform an online authorization.

It is also conceivable that the authorization data is stored on other storage media that comprises means for being coupled to the card reader for authorization purposes (a few examples of such media include a diskette, a smart card, a CD, a hard disk and any other means for storing electronic data.)

Scope

Thus the scope of the invention should be determined by the elements of the appended claims and their legal equivalents, and not by the specifics given.

I claim:

1. A read/write device, comprising:
means for coupling said read/write device with a computing device
means for coupling said read/write device with a portable electronic storage device
means for storing authorization information related to which portable electronic storage devices are authorized for use with said read/write device.
means for repeatedly updating said stored authorization information

2. A read/write device according to claim 1, wherein said read/write device is an electronic storage and transaction apparatus including communicating means and memory means for storing authorization information, comprising:
means for coupling said electronic storage and transaction apparatus with a portable electronic storage device;
means for storing in the memory means, authorization information representing those said portable electronic storage devices which is authorized to be used with said electronic storage and transaction apparatus.

3. An electronic storage and transaction apparatus according to claim 2, further comprising means for coupling said electronic storage apparatus with a computing device.

4. An electronic storage and transaction apparatus according to claim 2, wherein said electronic storage and transaction apparatus comprises means of reading information from a card

5. An electronic storage and transaction apparatus according to claim 4, wherein said card is an IC card.

6. An electronic storage and transaction apparatus according to claim 5, further comprising means to write information to said IC card.

7. An electronic storage and transaction apparatus according to claim 4, further comprising means to write information to a card.

8. An electronic storage and transaction apparatus according to claim 2, further comprising means for repeatedly updating said stored authorization information.

9. An electronic storage and transaction apparatus according to claim 8, comprising means for transferring, from an external data source, updated authorization information for storage in said electronic storage and transaction apparatus.

10. An electronic storage and transaction apparatus according to claim 9, wherein said external data source is a portable electronic storage device.

11. A read/write device according to claim 10 wherein said portable electronic storage device is an IC card.

12. An electronic storage and transaction apparatus according to claim 9, further comprising means for automatically coupling said electronic storage and transaction apparatus with said external data source over a network.

13. A system for authorizing a portable electronic storage device for use with an electronic storage and transaction apparatus including communicating means and means for storing authorization data, comprising:
An electronic storage and transaction apparatus, which comprises:
means for coupling said electronic storage and transaction apparatus to a computing device;
means for coupling said electronic storage and transaction apparatus to a portable electronic storage device;
means for reading from and writing to data on said portable electronic storage device;
means for storing authorization data in said electronic storage and transaction apparatus;
said storing authorization data representing those portable electronic storage devices which are authorized to be used with said electronic storage and transaction apparatus.
A portable electronic storage device, which comprises:
means for coupling said portable electronic storage device to said electronic storage and transaction apparatus;
means for storing data in said portable storage device.

14. A method for authorizing a portable electronic storage device for use with an electronic storage and transaction apparatus including communicating means and means for storing authorization data, comprising the following steps:
presenting said portable electronic storage device for communication with said electronic storage and transaction apparatus;
Reading data from said portable electronic storage device
Determining if said portable electronic storage device is authorized for use with said electronic storage and transaction apparatus

15. A method according to claim 14 further comprising the step of:
Storing information regarding authorized an unauthorized cards and/or card types in said electronic storage apparatus
